(19) United States
(12) Patent Application Publication
(10) Pub. No.: US 2021/0293976 A1
(43) Pub. Date: Sep. 23, 2021

(54) METHOD FOR SELECTING A RESTRICTED OR EMPTY SET OF HYPOTHESES OF POSSIBLE POSITIONS OF A VEHICLE

(71) Applicant: RENAULT s.a.s., Boulogne-Billancourt (FR)

(72) Inventors: Philippe BONNIFAIT, La Croix Saint Ouen (FR); Franck LI, Athis-Mons (FR); Javier IBANEZ-GUZMAN, Raizeux (FR)

(73) Assignee: RENAULT s.a.s., Boulogne-Billancourt (FR)

(21) Appl. No.: 16/975,942

(22) PCT Filed: Feb. 12, 2019
(86) PCT No.: PCT/EP2019/053453

§ 371 Date: Aug. 26, 2020

(30) Foreign Application Priority Data
Feb. 27, 2018 (FR) 1851706

(51) Int. Cl. G01S 19/50; G01C 21/30; G05D 1/02; G01S 19/39; G06F 16/29

(52) U.S. Cl. CPC G01S 19/50; G01C 21/30; G05D 1/0274; G05D 2201/0213; G01S 19/396; G06F 16/29; G05D 1/0278

(57) ABSTRACT

A method for selecting a restricted or empty set of hypotheses of possible positions of a vehicle from among a plurality of hypotheses includes acquiring a geolocated position of the vehicle by a geolocation system, acquiring a plurality of hypotheses of possible positions of the vehicle, determining a covariance of the geolocated position of the vehicle and a covariance of each acquired hypothesis, calculating, for each acquired hypothesis, a Mahalanobis distance as a function of the covariance of the geolocated position of the vehicle and of the covariance of the hypothesis, and selecting a restricted or empty set of hypotheses from among the acquired hypotheses, as a function of each calculated Mahalanobis distance.

### TECHNICAL FIELD TO WHICH THE INVENTION RELATES

The present invention relates generally to the field of mapping.

It relates more particularly to a method for selecting a restricted or empty set of hypotheses of possible positions of a vehicle from among a plurality of hypotheses.

The invention relates also to a vehicle comprising:
means for memorizing a map,
a geolocation system, and
a computer suitable for pre-positioning the vehicle on the map and for implementing a selection method as mentioned above.

### TECHNOLOGICAL BACKGROUND

To ensure the safety of autonomous vehicles and of partially automated vehicles, it is necessary to have a deep knowledge of the environment in which these vehicles move around.

In practice, the perception by a vehicle of its environment is done in two different ways, namely:
by using a map and a geolocation means of the vehicle, and
by using exteroceptive sensors (cameras, RADAR or LIDAR sensor, etc.).

The companies which create maps currently work on so-called “high definition” maps, that make it possible to obtain very detailed information on the features of the road network (lane width, ground markings, signaling panels, etc.).

These maps are embedded in vehicles equipped with geolocation means, which allows these vehicles to be situated on the map at a position estimated by a longitude and a latitude.

Unfortunately, it is found that this position is not always very accurate and reliable, which is then reflected by the vehicle being located out of the path actually taken. This problem can prove particularly hazardous in the case of an autonomous vehicle which uses this information for its direction.

To remedy this problem, a first technical solution consists in determining several possible positions for the vehicle, given the road taken and the geolocated position, and in selecting the most probable.

The major drawback with this solution is that it ultimately makes it possible to select only a single position, so that if an error is committed, the motor vehicle is not able to apprehend it, which can prove very dangerous.

Also known from the document EP1729145 is another solution which consists in processing the geolocation signals received from the satellites, in order to reduce the errors associated with a bad propagation of the signals to the vehicle.

The major drawback with this solution is that it uses exteroceptive sensors (gyroscopes, accelerometers, etc.) to determine the precise position of the vehicle, which can prove costly and which subordinates the reliability of this solution to the reliability of the sensors used.

### OBJECT OF THE INVENTION

In order to remedy the abovementioned drawbacks of the state of the art, the present invention proposes considering hypotheses of possible positions of the vehicle and performing a consistency test on these hypotheses in order to reduce their number to the minimum and, as far as possible, to a single solution.

More particularly, according to the invention, a method is proposed for selecting hypotheses as defined in the introduction, in which there are provided:
a step of acquiring at least one geolocated position of the vehicle by means of a geolocation system,
a step of acquiring a plurality of hypotheses of possible positions of a vehicle,
a step of determining the covariance of the geolocated position of the vehicle and the covariance of each acquired hypothesis,
a step of calculating, for each acquired hypothesis, a Mahalanobis distance based on the covariance of the geolocated position of the vehicle and of the covariance of said hypothesis, and
a step of selecting a restricted or empty set of hypotheses from among the acquired hypotheses, based on each calculated Mahalanobis distance.

This method thus involves an arbitration method which makes it possible to check the consistency of each hypothesis with the geolocated position of the vehicle, so as to be able to indicate whether or not the selected hypothesis is usable.

The solution claimed is advantageous in that it does not assess the accuracy of the geolocation data received, but rather the consistency of the running of the algorithm using these data. It therefore does not require the use of additional sensors, so that it is inexpensive and very reliable.

More generally, the proposed solution makes it possible to step back from the data available and judge whether the information is usable in the context of the control of an autonomous vehicle, by very reliably addressing the issue of knowing whether or not it is possible to have fully confidence in the selected hypothesis.

Another advantage of the proposed solution is that, because it makes it possible to indicate whether the data used in the algorithm are coherent, it makes it possible not only to determine whether a hypothesis is correct but also to diagnose a fault in the geolocation system. This advantage will emerge more clearly on reading the rest of this explanation.

Other advantageous and nonlimiting features of the method according to the invention are as follows:
at the end of the selection, provision is made to determine the usable or non-usable nature of each selected hypothesis, based on the number of hypotheses selected;
in the selection step, a chi-square test is performed for each Mahalanobis distance;
prior to the step of acquiring each hypothesis, provision is made to:
   pre-position the vehicle on a map at its geolocated position,
   distribute particles on the map around the geolocated position, each particle corresponding to a possible position of the vehicle,
   apply a particle filter to the particles, by notably assigning a weight to each particle, and
   combine the particles deriving from the particle filter into a restricted number of hypotheses, each linked to a traffic lane memorized in the map;
in the selection step, provision is made to select only the hypotheses for which an indicator, calculated as a function of the weights of the particles which make up this hypothesis, is greater than a determined threshold;
in the determination step, a covariance matrix of the geolocated position of the vehicle and a covariance matrix of each acquired hypothesis are calculated;
if the selected set of hypotheses is empty and/or if several hypotheses remain present, a step of transmission of an alert is provided.

The invention relates also to a vehicle comprising:
means for memorizing a map,
a geolocation system, and
a computer adapted to pre-position the vehicle on the map and to implement a section method as mentioned above.

### DETAILED DESCRIPTION OF AN EXEMPLARY EMBODIMENT

The description given below in light of the attached drawings, given as nonlimiting examples, will give a good understanding as to what the invention consists of and how it can be produced.

In the attached drawings:

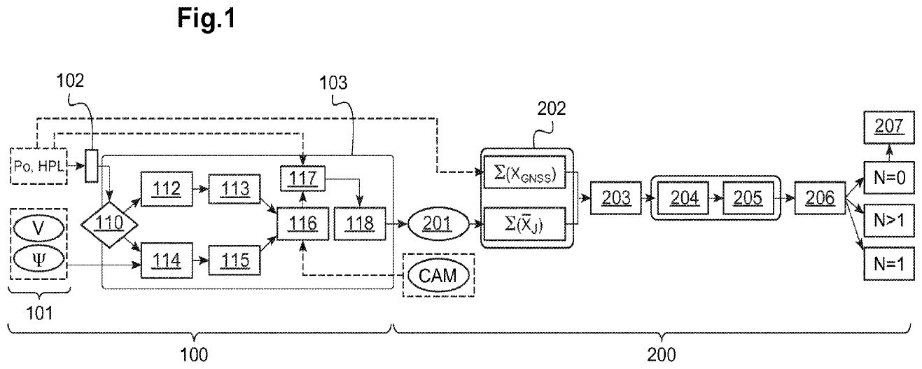

FIG. 1 is a diagram illustrating the different steps of a method according to the invention,

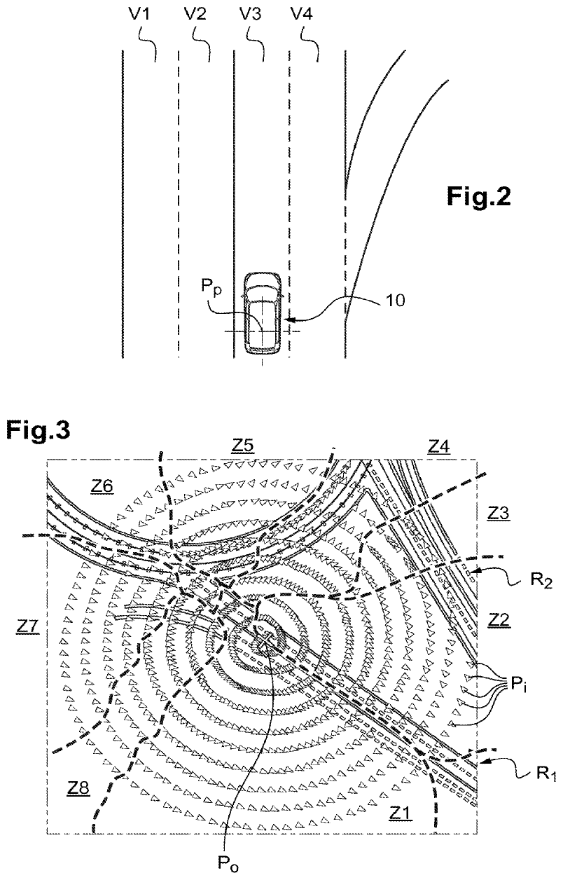

FIG. 2 is a plan view of a vehicle traveling on a road,

FIG. 3 is a schematic view of particles distributed on a map,

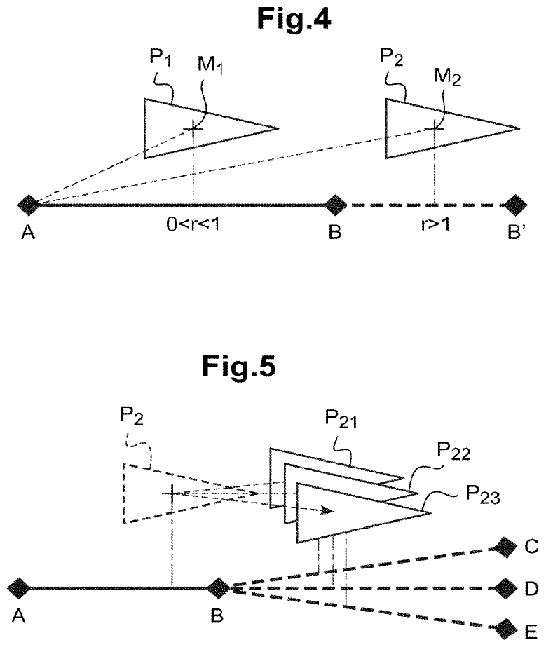

FIG. 4 is a schematic view of two particles situated along two successive road sections, and

FIG. 5 is a schematic view of four particles situated alongside four road sections.

In FIG. 2, a motor vehicle 10 is represented which takes the form of a car and which is traveling on a portion of road with four traffic lanes V1, V2, V3, V4.

Hereinafter in the description, interest will be focused more particularly on the location of this motor vehicle 10 on the map but the invention will not be limited to such an example. It will thus apply notably to the location of any land, sea, air or space vehicle on a map.

The motor vehicle 10 considered here conventionally comprises a chassis, a power train, a steering system, a braking system, an electronic and/or computing computation unit, hereinafter called computer.

The computer is connected to so-called “proprioceptive” sensors, which make it possible to accurately measure the speed of the vehicle and the angular yaw speed of the vehicle.

The computer is preferably also connected to “exteroceptive” sensors, which make it possible to perceive the immediate environment of the motor vehicle (they can be cameras, RADAR sensors, LIDAR sensors, etc.).

The computer is also connected to a geolocation system which makes it possible to evaluate the geolocated position P₀ of the vehicle 10, here defined by a latitude and a longitude. It can for example be a GPS system.

It will be considered here that this geolocation system is also adapted to transmit to the computer a datum called “horizontal protection level HPL”. This datum, well known to the person skilled in the art, corresponds to the measurement uncertainty of the geolocated position P₀. Its value varies for example as a function of the number of satellites from which the geolocation system receives data, the quality of the reception of the signals, of the quality of the geolocation system used, etc.

Along the same lines, it will also be considered here that this geolocation system is adapted to transmit to the computer a covariance matrix relating to this same uncertainty.

The motor vehicle 10 considered could be semi-automated, so that its computer can for example trigger emergency braking when the driver has not perceived a danger and has not himself or herself taken appropriate action. The system described will also be able to be deployed on a conventional vehicle in the context of learning driving conditions for example.

However, hereinafter in this explanation, it will be considered that the motor vehicle 10 is of the autonomous type, and that the computer is adapted to control the power train, the steering system, and the braking system of the vehicle.

The computer then comprises a computer memory which stores data used in the context of the automatic control of the vehicle, and notably in the context of the method described below.

It notably memorizes a computer application, consisting of computer programs comprising instructions, the execution of which by a processor allows the method described hereinbelow to be implemented by the computer.

It also memorizes a so-called “high-definition” topographic map.

This map stores numerous data.

It comprises, first of all, information relating to the topography of the roads. This topography is memorized here in the form of road sections (or “links”). Each road section is defined here as a portion of a single traffic lane of a road, whose features are constant over all its length (form of the ground markings identical along the road section, constant width of this road section, etc.).

The map also stores other data characterizing each road section, including the width of the traffic lane, the form of the markings on the ground situated on either side of the traffic lane, the position and the form of each panel bordering the road at the road section, the identifiers of the preceding and next road sections, etc.

The method implemented by the computer to estimate the precise position Pₚ of the motor vehicle 10 on the map comprises two major operations, including a particle filtering operation 100, and a hypothesis selection operation 200 (see FIG. 1).

The hypothesis selection operation 200 uses the results of the particle filtering operation 100, so that it is implemented after the latter.

The first step is therefore to describe the first, particle filtering operation 100.

This operation is implemented recursively, that is to say in loop fashion and with regular time steps.

It comprises three main steps.

The first step 101 consists, for the computer, in acquiring different data via the sensors to which it is connected.

The computer thus acquires the geolocated position P₀ of the motor vehicle 10 and the horizontal protection level HPL which is associated with it. These data are acquired using the geolocation system which supplies a latitude, a longitude and a horizontal protection level HPL.

The computer also acquires data relating the dynamics of the motor vehicle 10. It thus acquires the speed V of the vehicle and its angular yaw speed Ψ.

The second step 102 is a step of pre-positioning of the vehicle 10 on the map, at the geolocated position P₀ acquired.

The third step 103 is a particle filtering step during which possible positions of the vehicle (or more accurately possible postures of the vehicle), called particles Pᵢ, are processed in order to determine the precise position Pₚ of the vehicle 10 on the map (or more precisely the precise posture of the vehicle on the map).

Each particle Pᵢ can be defined by:
two coordinates xᵢ, yᵢ that make it possible to define the position of the particle in a cartesian reference frame (these coordinates are linked to the latitude and longitude acquired),
a yaw angle making it possible to define the angle that the particle makes relative to a given direction such as north, and
an identifier of the section of the map with which the particle Pᵢ is associated.

In FIGS. 3 to 5, particles P₁ are represented in the form of isosceles triangles, each triangle having a center Mᵢ which corresponds to the position of the particle on the map, and an orientation which corresponds to the yaw angle of the particle on the map.

As FIG. 1 shows, the third, particle filtering step 103, more accurately consists of several substeps that can now be described in more detail.

The first substep 110 consists in determining whether or not the current phase is a phase of initialization of the particle filter, which is for example the case on starting up the motor vehicle 10.

It is then possible to adopt this situation, in which case no particle has yet been generated.

The next substep 112 then consists in creating and distributing particles Pᵢ on the map, given the geolocated position P₀ of the vehicle 10.

For that, the particles Pᵢ are distributed in a disk centered on the geolocated position P₀ of the vehicle 10, the radius of which is, here, equal to the horizontal protection level HPL.

They are more specifically distributed in a spiral, with a constant angular difference. The characteristics of the spiral and the angular difference between the particles P₁ are chosen based on the number of particles Pᵢ that are to be generated.

This number is greater than 100, and preferentially of the order of 1000. It is determined in such a way as to obtain a sufficient accuracy, without in any way overloading the computer.

At this stage, the particles Pᵢ are not yet oriented.

Each particle Pᵢ thus corresponds to a possible position that the vehicle could have, given the error affecting the geolocation system.

Some particles, as can be seen in FIG. 3, are situated outside of the road. That illustrates the fact that the particles are not constrained on the map and that they can move around within a two-dimensional space. The filter is therefore very flexible and makes it possible to initially consider a very large number of different solutions, the most absurd of which will then be eliminated by the particle filter.

During a subsequent substep 113, the computer associates each particle Pᵢ with its closest road section.

The method chosen here is of the “point-to-curve” type. It consists in associating each particle Pᵢ with the road section which is closest in the Euclidian distance sense.

As an illustrative example, in FIG. 4, it is thus observed that the particle P₁ is associated with the road section AB.

At this stage, the computer can orient the particles Pᵢ notably on the basis of the orientation of the road section with which each particle is associated (and possibly also based on the dynamics of the vehicle).

The method then continues with a substep 116 which will be described later.

As was described above, the first substep 110 consisted in determining whether or not the current phase was a phase of initialization of the particle filter.

It is now possible to consider that that is not the case and that the process has already been initialized previously.

In this case, during a substep 114, the computer updates the particles Pᵢ on the map.

For that, the particles Pᵢ are all moved on the map based on information relating to the dynamics of the vehicle.

The two data that are the speed V of the vehicle and the angular yaw speed V of the motor vehicle 10 are in fact employed to displace all the particles Pᵢ by a given distance and to reorient the particles by a given angle. A random noise is added to these two data, independently for each particle, in order to promote a position diversity among the particles after the move.

It will be noted that this substep does not this time use the geolocated position P₀ of the motor vehicle.

During a subsequent substep 115, the computer re-associates each particle Pᵢ with a road section.

It more specifically determines which particles Pᵢ must be associated with a new road section, and it identifies this new road section.

To understand how the computer works, reference can be made to FIG. 4 in which two particles P₁, P₂, centered on points M1, M2, are represented and on which a road section AB is also represented.

It is considered here that, in the preceding time step, the two particles P₁, P₂ were associated with one and the same road section AB, then that they were displaced during the substep 114.

The computer then determines for each particle Pᵢ a ratio r, in order to know whether each particle should or should not be associated with a new road section.

This ratio r is calculated according to the following formula:

$$r = \frac{( \vec{AB} \cdot {\vec{AM}}_{l} )}{{‖ \vec{AB} ‖}^{2}}$$

In the case where this ratio r lies between 0 and 1, the association of the particle Pᵢ with its original road section must not be changed. That is the case here for the particle P₁.

In the case where this ratio is negative, the association of the particle Pᵢ with its road section must be changed. This particle should more specifically be associated with the preceding road section or with one of the preceding road sections.

In the case where this ratio is strictly greater than 1, the association of the particle Pᵢ with its road section must be changed. This particle should more specifically be associated with the next road section or with one of the next road sections.

Several situations can thus be encountered.

In the situation of FIG. 4 in which the road section AB comprises only a single successor BB′, the particle P₂ is associated with this successor (inasmuch as the ratio r lies between 0 and 1 with this new road section, otherwise another successor is considered).

In the situation of FIG. 5 in which the road section AB comprises multiple successors BC, BD, BE, the particle P₂ considered in the preceding time step is cloned into as many particles P₂₁, P₂₂, P₂₃ as there are successors BC, BD, BE.

It is also possible to provide for the particle to be cloned fewer times if some of the successors cannot be considered, given the dynamics of the vehicle.

In another situation not represented in the figures, it is possible that the particle must be associated with another road section parallel to the road section with which it was associated in the preceding time step (which will arrive notably when the vehicle laterally changes traffic lane, for example to overtake another vehicle). That is made possible because the particles are not constrained to move only on the same road section. This situation can be detected given the new position of the particles and the data stored in the map (information on ground markings, traffic lane widths, etc.). In a variant, it is possible to envisage this situation being detected also using cameras embedded in the vehicle.

During a substep 116 which follows both the substep 115 and the substep 113, the computer calculates the likelihood of wᵢ of each particle Pᵢ.

The likelihood of a particle is expressed here by its weight wᵢ. The greater the weight of a particle, the more probable it is that the particle considered corresponds to the exact position of the motor vehicle 10.

This weight can be calculated in different ways.

In a first embodiment, the weight wᵢ of each particle Pᵢ is calculated only on the basis of data deriving from the map.

It is more specifically determined based on the Euclidian distance which separates the particle considered from the road section with which it is associated (this weight is for example inversely equal to this distance).

In a second embodiment, the weight wᵢ of each particle Pᵢ is calculated also on the basis of data deriving from exteroceptive sensors, provided that these data are deemed reliable.

It is in fact possible to imagine increasing or reducing the weight of the particle considered based on lateral information originating from the cameras CAM of the vehicle. These cameras are actually capable of detecting the ground marking lines and of returning them to the computer in the form of a polynomial model. The computer can then check whether the form of these lines corresponds to that of the ground markings stored in the map, and adjust the weight of the particle accordingly.

It can be noted that the ground markings are not always detected by the cameras. That can be due to difficult conditions for the sensors such as poor lighting, a wet road, deleted markings, etc. In these particular cases, the camera indicates to the computer a low level of confidence and the calculation of the weight is then based solely on the data supplies by the map as described in the first embodiment.

Whatever the method used, the method continues with a substep 117 of selection of a restricted set of particles Pᵢ, so as to eliminate those which were too far away from the instantaneous geolocated position P₀ of the motor vehicle 10.

To implement this substep, the computer acquires the new geolocated position P₀ of the motor vehicle 10, then it calculates the distance separating each particle Pᵢ from this instantaneous geolocated position P₀.

If this distance is greater than the horizontal protection level HPL, the weight wᵢ of the corresponding particle Pᵢ is set to zero, which will allow this particle to be automatically eliminated thereafter.

Otherwise, the weight wᵢ of the corresponding particle Pᵢ is not modified.

During a subsequent substep 118, the computer determines whether or not it is necessary to resample the particles Pᵢ on the map.

For that, it uses an indicator N_{eff}, which is calculated based on the weight wᵢ of the particles Pᵢ and on the number of particles Pᵢ.

If this indicator N_{eff} goes below a predetermined threshold (stored in the read-only memory of the computer), then the computer resamples the particles Pᵢ on the map. Otherwise, the particles Pᵢ are kept in their state.

As is known, a resampling consists in considering the particles (hereinafter called original particles) in their set, and in drawing new particles from this original set.

To resample the particles, the computer could use a conventional method during which it would randomly draw a predefined number of new particles from the original set of particles Pᵢ, the probability of drawing each particle Pᵢ being proportional to the weight wᵢ of this particle Pᵢ. However, this method generally causes a depletion of the particles, since it is always those which have a very high weight which are drawn.

Preferentially, the computer here uses rather a resampling method said to have “low variance” (called “low variance resampling”). This method in fact favors maintaining a good distribution of the particles on the map. This method consists in randomly drawing a redefined number of new particles from the original set of particles P₁, the probability of drawing each particle Pᵢ being a function of the weight wᵢ of this particle P₁ but not this time being proportional to this weight.

At this stage, the computer could simply recommence the loop of the substeps 114 to 118 until particles are obtained that are all situated around one and the same point, which would be considered to correspond to the precise position Pₚ of the motor vehicle 10 on the map.

That is not however the option which is chosen here. Thus, as was explained previously, once the substep 118 is completed, a hypothesis selection operation 200 is provided.

This hypothesis selection operation 200 is implemented once the particle filtering operation 100 has converged and has given a restricted number of solutions (the particles being, for example, grouped around a number of points below a predetermined threshold).

This hypothesis selection operation 200 is implemented recursively, that is to say in a loop and with regular time steps. It comprises several substeps.

During a first step 201, the computer selects “hypotheses”.

For that, it considers the particles Pᵢ in different sets within each of which the particles are all associated with one and the same traffic lane (or, as a variant, with one and the same road section).

The benefit of working on hypotheses is that it will then be possible to select all the most likely hypotheses, which will make it possible, on the one hand, to keep the good hypothesis from among those selected, and, on the other hand, to verify the validity of each selected hypothesis.

The hypotheses can be formulated in the form of assertions such as “the vehicle is situated in the traffic lane whose reference is . . . ”.

To have a good understanding of what a hypothesis corresponds to within the meaning of the present explanation, the particles have been grouped together in FIG. 3 in eight sets Z₁, Z₂, Z₃, Z₄, Z₅, Z₆, Z₇, Z₈, each corresponding to one hypothesis.

As an example, the particles of the set Z₁ correspond to the hypothesis “the vehicle is situated in the right hand traffic lane of the road R₁”.

The particles of the set Z₂ correspond to the hypothesis “the vehicle is situated in the left hand traffic lane of the road R₁”.

The particles of the set Z₃ correspond to the hypothesis “the vehicle is situated in the left hand traffic lane of the road R₂”.

The particles of the set Z₄ correspond to the hypothesis “the vehicle is situated on the roundabout, between its junctions with the roads R₁ and R₂”.

In considering that a number “J” of hypotheses is found (in FIG. 3, J=8), each hypothesis can also be expressed in the form of a vector of mean coordinates X̅ⱼ whose components correspond to the sum of the coordinates of the particles Pᵢ of this hypothesis, weighted by the weight wᵢ of these particles.

The computer can assign each hypothesis a “confidence index” equal to the sum of the weights wᵢ of the particles P₁ of this hypothesis.

During a second step 202, the computer will determine the covariance matrix Σ(X̅ⱼ) of each hypothesis and the covariance matrix Σ(X_{GNSS}) of the geolocated position P₀ of the vehicle 10.

Manipulation such covariance matrices in fact makes it possible to characterize the uncertainty linked to each hypothesis and that linked to the geolocated position P₀ supplied by the geolocation system.

As was explained above, the covariance matrix Σ(X_{GNSS}) linked to the geolocated position P₀ of the vehicle 10 is, here, directly transmitted to the computer by the geolocation system. Here, it is a 2×2 matrix.

Concerning the covariance matrix Σ(X̅ⱼ) linked to each hypothesis, it is calculated on the weights wᵢ of the set of particles Pᵢ associated with that hypothesis. This is also a 2×2 matrix, the expression of which is as follows:

$$\sum ( {\overline{X}}_{j} ) = [ \begin{matrix}{σ}_{x}^{{j}^{2}} & {σ}_{xy}^{j} \\ {σ}_{xy}^{j} & {σ}_{y}^{{j}^{2}}\end{matrix} ]$$

$$with$$

$$\{ \begin{matrix}{σ}_{x}^{{j}^{2}} = \frac{1}{1 - {\sum }_{i = 0}^{{n}_{j}} {w}^{{i}^{2}}} \cdot {\sum }_{i = 0}^{{n}_{j}} {{w}^{i} ( {x}^{i} - {\overline{x}}_{j} )}^{2} \\ {σ}_{y}^{{j}^{2}} = \frac{1}{1 - {\sum }_{i = 0}^{{n}_{j}} {w}^{{i}^{2}}} \cdot {\sum }_{i = 0}^{{n}_{j}} {{w}^{i} ( {y}^{i} - {\overline{y}}_{j} )}^{2} \\ {σ}_{xy}^{j} = \frac{1}{1 - {\sum }_{i = 0}^{{n}_{j}} {w}^{{i}^{2}}} \cdot {\sum }_{i = 0}^{{n}_{j}} {w}^{i} ( {x}^{i} - {\overline{x}}_{j} ) ( {y}^{i} - {\overline{y}}_{j} )\end{matrix} \\ and \\ {\overline{x}}_{j} = {\sum }_{i = 0}^{{n}_{j}} {w}^{i} {x}^{i} , {\overline{y}}_{j} = {\sum }_{i = 0}^{{n}_{j}} {w}^{i} {y}^{i} .$$

It is then necessary to determine the extent to which each hypothesis is “consistent”, given the geolocated position P₀ supplied by the geolocation system and by taking account of the error linked to the measurement of this geolocated position.

For that, during a step 203, a mathematical object is used that is called Mahalanobis distance D_{Mj}, the expression of which is as follows:

$${D}_{{M}_{j}} ( {\overline{X}}_{j} ) = \sqrt{{( {\overline{X}}_{j} - {X}_{GNSS} )}^{T} \cdot {[ \sum ( {\overline{X}}_{j} ) + \sum ( {X}_{GNSS} ) ]}^{- 1} \cdot ( {\overline{X}}_{j} - {X}_{GNSS} )}$$

in which X_{GNSS} corresponds to the “geolocated position P₀”.

The Mahalanobis distance is in fact an object which makes it possible to evaluate the consistency between two uncertain situations, by taking account of the covariances of the variables (that is the doubt associated with each variable).

Then, during a step 204, provision is made to select a first restricted (even empty) set of hypotheses from among the hypotheses acquired in the step 201.

For that, a chi-square (X²) test is performed for each Mahalanobis distance D_{Mj}.

In practice, each Mahalanobis distance D_{Mj}, is, here, compared to a critical threshold, determined for a given risk of false detection, to determine whether the hypothesis considered is or is not consistent with the geolocated position P₀.

If the hypothesis considered and the geolocated position P₀ are consistent in the CHI-square test sense, the hypothesis is retained.

Otherwise, if the hypothesis considered and the geolocated position P₀ are not consistent in the CHI-square test sense, the hypothesis is rejected.

It will be noted here that if a hypothesis is retained, that does not necessarily mean that that hypothesis is true. In fact, at this stage, several hypotheses can be retained.

On the other hand, if a hypothesis is rejected, that does not necessarily that that hypothesis was false. It may in fact be that the great error affects the measurement of the geolocated position P₀. In this case, a true hypothesis may be rejected. As clearly emerges hereinafter in this explanation, that will in no way affect the reliability of the method proposed here.

During a subsequent step 205, provision is made to select a second restricted (even empty) set of hypotheses from among the hypotheses selected in the step 204.

It will be noted here that this second selection could have been applied before the first selection without in any way affecting the progress of the method.

This second selection consists in retaining only the hypotheses that are “likely”, for which an indicator, linked to the weights wᵢ of the particles Pᵢ that make up this hypothesis, is greater than a determined threshold. The objective is in fact to eliminate the hypotheses which have satisfied the CHI-square consistency test, but which are improbable.

For that, the computer eliminates the hypotheses for which the confidence index (which, it will be recalled, is equal to the sum of the weights wᵢ of the particles Pᵢ of the hypothesis considered) is below a determined threshold. This threshold is, here, invariable and memorized in the read-only memory of the computer.

At the end of these two hypothesis selection steps, the computer has retained a number N of hypotheses that are not only consistent but are also likely.

During a step 206, provision is then made to determine the usable or non-usable nature of each selected hypothesis, based on this number N.

Three cases can then be envisaged.

The first case is that in which the number N is equal to 1. In this case, since a single hypothesis has been retained, this hypothesis is considered to be fair and usable to generate an autonomous vehicle driving setpoint. If follows therefrom that the computer can rely on it. In this case, the computer can then consider that the mean position of the particles of this hypothesis corresponds to the precise position Pₚ of the vehicle 10.

The second case is that in which the number N is strictly greater than 1. In this case, since several hypotheses have been retained, none is considered usable to generate an autonomous vehicle driving setpoint.

The last case is that in which the number N is equal to 0. In this case, as in the preceding case, since no hypothesis has been retained, no position is considered usable to generate an autonomous vehicle driving setpoint. Moreover, the computer can advantageously deduce from this situation that there is an inconsistency between the measurements performed by the geolocation system and the acquired hypotheses, which is probably due to a problem affecting the geolocation system. In this eventuality, a step 207 is provided in which an alert is transmitted to the driver and/or the control unit of the vehicle in autonomous mode, so that the latter can take the requisite measures (emergency stop, driving in degraded mode, etc.).

1-8. (canceled)

9. A method for selecting a restricted or empty set of hypotheses of possible positions of a vehicle from among a plurality of hypotheses, comprising:
acquiring a geolocated position of the vehicle by a geolocation system;
acquiring a plurality of hypotheses of possible positions of the vehicle;
determining a covariance of the geolocated position of the vehicle and a covariance of each acquired hypothesis;
calculating, for each acquired hypothesis, a Mahalanobis distance as a function of the covariance of the geolocated position of the vehicle and of the covariance of said hypothesis; and
selecting a restricted or empty set of hypotheses from among the acquired hypotheses, as a function of each calculated Mahalanobis distance.

10. The selection method as claimed in claim 9, wherein, at an end of the selecting, provision is made to determine a usable or non-usable nature of each selected hypothesis, based on a number of hypotheses selected.

11. The selection method as claimed in claim 9, wherein, in the selecting, a chi-square test is performed for each Mahalanobis distance.

12. The selection method as claimed in claim 9, wherein, prior to the acquiring a plurality of hypothesis, provision is made to:
pre-position the vehicle on a map at the geolocated position,
distribute particles on the map around the geolocated position, each particle corresponding to a possible position of the vehicle,
apply a particle filter to the particles, by notably assigning a weight to each particle, and
combine the particles deriving from the particle filter into a restricted number of hypotheses each linked to a traffic lane memorized in the map.

13. The selection method as claimed in claim 12, wherein, in the selecting, provision is made to select only the hypotheses for which an indicator, calculated based on the weights of the particles which make up this hypothesis, is greater than a determined threshold.

14. The selection method as claimed in claim 9, wherein, in the determining, a covariance matrix of the geolocated position of the vehicle and a covariance matrix of each acquired hypothesis are calculated.

15. The selection method as claimed in claim 9, wherein, when the selected set of hypotheses is empty and/or if several hypotheses remain present, an alert is transmitted.

16. A vehicle comprising:
means for memorizing a map,
a geolocation system, and
a computer suitable for pre-positioning the vehicle on the map,
wherein the computer is configured to implement the selection method as claimed in claim 9.
